(19) United States
(12) Patent Application Publication
(10) Pub. No.: US 2019/0205025 A1
(43) Pub. Date: Jul. 4, 2019

(54) ELECTRONIC DRAWING BOARD, REMOTE TEACHING DRAWING BOARD, DRAWING SIMULATION METHOD AND APPARATUS

(71) Applicant: BOE TECHNOLOGY GROUP CO., LTD., Beijing (CN)

(72) Inventors: Wenchu DONG, Beijing (CN); Honglei ZHANG, Beijing (CN)

(21) Appl. No.: 16/044,851

(22) Filed: Jul. 25, 2018

(30) Foreign Application Priority Data
Jan. 2, 2018 (CN) 201810002936.6

(51) Int. Cl. G06F 3/0488; G06F 3/041; G06F 3/0484; G06F 3/0354; G09B 11/00; G09B 9/00

(52) U.S. Cl. CPC G06F 3/04883; G06F 3/0414; G09B 9/00; G06F 3/0354; G09B 11/00; G06F 3/04842

(57) ABSTRACT

The present application relates to an electronic drawing board, a remote teaching drawing board, a drawing simulation method and apparatus. The electronic drawing board includes: a pressure touch sensing screen configured to sense a contact of a brush with the screen and display a stroke according to a thickness, direction, color, and gradation effect of the stroke; and a drawing simulation processor configured to determine the thickness of the stroke from a contact duration of the brush with the screen when the brush is wielded on the screen, determine the color of the stroke from a type and amount of a pigment taken up by the brush and the contact duration, and determine a gradation speed of the stroke from an amount of moisture contained in the brush, and determine a gradation area of the stroke from the contact duration.

### CROSS-REFERENCE TO RELATED APPLICATIONS

The present application claims priority to China Patent Application No. 201810002936.6 filed on Jan. 2, 2018, the disclosure of which is incorporated by reference herein in its entirety.

### TECHNICAL FIELD

The present disclosure relates to the field of electronic technology, and in particular, to an electronic drawing board, a remote teaching drawing board, a drawing simulation method and apparatus.

### BACKGROUND

With the rapid development of electronic technology, the use of various electronic products including electronic drawing boards is becoming more and more popular.

Due to a series of excellent features such as portability and ease of use, electronic drawing boards have received extensive attention as an important tool for remote teaching.

### SUMMARY

According to a first aspect of embodiments of the present disclosure, there is provided an electronic drawing board, comprising a pressure touch sensing screen and a drawing simulation processor. The pressure touch sensing screen is configured to sense a contact of a brush with the screen and display a stroke according to a thickness, direction, color, and gradation effect of the stroke. The drawing simulation processor is configured to determine the thickness of the stroke from a contact duration of the brush with the screen when the brush is wielded on the screen, determine the color of the stroke from a type and amount of a pigment taken up by the brush and the contact duration of the brush with the screen when the brush is wielded on the screen, and determine a gradation speed of the stroke from an amount of moisture contained in the brush, and determine a gradation area of the stroke from the contact duration of the brush with the screen when the brush is wielded on the screen.

In some embodiments, the drawing simulation processor is configured to determine an amount of a pigment taken up by the brush from the number of times the brush is dipped in the pigment and a pigment-dipping duration, and determine an amount of moisture contained in the brush from the number of times the brush is dipped in water and a water-dipping duration.

In some embodiments, in a case that the brush is a writing brush, the drawing simulation processor is configured to: determine an amount of moisture contained in the brush from the number of times the brush is dipped in water, a water-dipping duration, and a water-dipping portion of the brush; determine an amount of a pigment taken up by the brush from the number of times the brush is dipped in the pigment, a pigment-dipping duration, and a pigment-dipping portion of the brush; and determine the thickness, gradation area and color of the stroke from a contact portion of the brush with the screen when the brush is wielded on the screen.

In some embodiments, the drawing simulation processor is configured to determine the water-dipping portion and the pigment-dipping portion of the brush, and the contact portion of the brush with the screen when the brush is wielded on the screen, from a brush type and a magnitude of a contact force between the brush and the screen.

In some embodiments, the drawing simulation processor is further configured to determine the color, gradation speed and gradation area of the stroke from a paper type.

In some embodiments, the drawing simulation processor is further configured to determine a wrinkled effect caused by the brush on a paper from the paper type.

In some embodiments, the pressure touch sensing screen comprises: a display having a display region and configured to display the stroke from the thickness, direction, color, and gradation effect of the stroke; and a pressure sensor arranged to be overlapped with the display region of the display and configured to sense the contact of the brush with the screen of the display.

In some embodiments, the drawing simulation processor is further configured to determine the color, gradation speed and gradation area of the stroke from at least one of history data and external data of the electronic drawing board.

According to a second aspect of embodiments of the present disclosure, there is provided a remote teaching drawing board, comprising at least one electronic drawing board according to any one of the previous embodiments.

In some embodiments, the remote teaching drawing board comprising: a plurality of the electronic drawing boards, wherein the pressure touch sensing screens of a portion of the electronic drawing boards are configured for inputting painting operations, and the pressure touch sensing screens of the other electronic drawing boards are configured for outputting painting data.

According to a third aspect of embodiments of the present disclosure, there is provided a drawing simulation method, comprising: determining a thickness of a stroke from a contact duration of a brush with a screen of an electronic drawing board when the brush is wielded on the screen, determining a color of the stroke from a type and amount of a pigment taken up by the brush and a contact duration of the brush with the screen when the brush is wielded on the screen, and determining a gradation speed of the stroke from an amount of moisture contained in the brush, and determining a gradation area of the stroke from the contact duration of the brush with the screen when the brush is wielded on the screen.

In some embodiments, the amount of a pigment taken up by the brush is determined according to the number of times the brush is dipped in the pigment and a pigment-dipping duration, and the amount of moisture contained in the brush is determined according to the number of times the brush is dipped in water and a water-dipping duration.

In some embodiments, in a case that the brush is a writing brush, the amount of moisture contained in the brush is determined from the number of times the brush is dipped in water, a water-dipping duration, and a water-dipping portion of the brush; the amount of a pigment taken up by the brush is determined from the number of times the brush is dipped in the pigment, a pigment-dipping duration, and a pigment-dipping portion of the brush; and the thickness, gradation area and color of the stroke is determined from a contact portion of the brush with the screen when the brush is wielded on the screen.

In some embodiments, the water-dipping portion, the pigment-dipping portion of the brush and the contact portion of the brush with the screen when the brush is wielded on the screen are determined from a brush type and a magnitude of a contact force between the brush and the screen.

In some embodiments, the drawing simulation method further comprising: determining the color, gradation speed and gradation area of the stroke from a paper type.

In some embodiments, the drawing simulation method further comprising: determining a wrinkled effect caused by the brush on a paper from the paper type.

In some embodiments, the drawing simulation method further comprising: determining the color, gradation speed and gradation area of the stroke from at least one of history data and external data of the electronic drawing board.

According to a fourth aspect of embodiments of the present disclosure, there is provided a drawing simulation apparatus, comprising: a stroke simulation module for determining a thickness of a stroke from a contact duration of a brush with a screen of an electronic drawing board when the brush is wielded on the screen, and a color simulation module for determining a color of the stroke from a type and amount of a pigment taken up by the brush and a contact duration of the brush with the screen when the brush is wielded on the screen, a gradation simulation module for determining a gradation speed of the stroke from an amount of moisture contained in the brush, and determining a gradation area of the stroke from the contact duration of the brush with the screen when the brush is wielded on the screen.

According to a fifth aspect of embodiments of the present disclosure, there is provided a drawing simulation apparatus, comprising: a memory; a processor coupled to the memory, the processor configured to, based on instructions stored in the memory, carry out the drawing simulation method according to any one of the previous embodiments.

According to a sixth aspect of embodiments of the present disclosure, there is provided a computer-readable storage medium on which a computer program is stored, which when executed by a processor implements the drawing simulation method according to any one of the previous embodiments.

Other features and advantages of the present invention will become apparent from the following detailed description of exemplary embodiments of the present disclosure with reference to the accompanying drawings.

### BRIEF DESCRIPTION OF THE DRAWINGS

The accompanying drawings, which constitute part of this specification, illustrate exemplary embodiments of the present disclosure and, together with this specification, serve to explain the principles of the present disclosure.

The present disclosure will be more clearly understood from the following detailed description with reference to the accompanying drawings, in which:

FIG. 1 is a schematic diagram illustrating the structure of an electronic drawing board according to some embodiments of the present disclosure;

FIG. 2 is a schematic diagram illustrating an interface of the electronic drawing board according to some embodiments of the present disclosure;

FIG. 3A is a schematic diagram illustrating a stroke simulation according to some embodiments of the present disclosure;

FIG. 3B is a schematic diagram illustrating a gradation simulation according to some embodiments of the present disclosure;

FIG. 3C is a schematic diagram illustrating a paper type simulation according to some embodiments of the present disclosure;

FIG. 4 is a flowchart illustrating the steps of a drawing simulation method according to some embodiments of the present disclosure;

FIG. 5 is a schematic diagram illustrating the structure of a drawing simulation apparatus according to some embodiments of the present disclosure;

FIG. 6 is a schematic diagram illustrating the structure of a drawing simulation apparatus according to some other embodiments of the present disclosure.

It should be understood that the dimensions of the various parts shown in the drawings are not drawn to the actual scale. In addition, the same or similar reference signs are used to denote the same or similar components.

### DETAILED DESCRIPTION

Various exemplary embodiments of the present disclosure will now be described in detail with reference to the accompanying drawings. The following description of the exemplary embodiments is merely illustrative and is in no way intended as a limitation to the present disclosure, its application or use. The present disclosure may be implemented in many different forms, which are not limited to the embodiments described herein. These embodiments are provided to make the present disclosure thorough and complete, and fully convey the scope of the present disclosure to those skilled in the art. It should be noticed that: relative arrangement of components and steps, material composition, numerical expressions, and numerical values set forth in these embodiments, unless specifically stated otherwise, should be explained as merely illustrative, and not as a limitation.

Unless otherwise defined, all terms (including technical and scientific terms) used herein have the same meaning as commonly understood by one of ordinary skill in the art to which exemplary embodiments in accordance with principles of inventive concepts belong. It will also be understood that terms defined in such general-purpose dictionaries should be interpreted as having a meaning that is consistent with their meaning in the context of the relevant art, and not to be interpreted in an idealized or overly formal sense, unless explicitly defined herein.

Techniques, methods, and apparatus known to those of ordinary skill in the relevant art may not be discussed in detail, but where appropriate, these techniques, methods, and apparatuses should be considered as part of the specification.

The related remote teaching drawing boards are limited to remote voice transmission, video transmission, and remote writing display on electronic writing boards, and it is impossible to realize real operation delivery of drawing knowledge such as coloring, gradating, strength, and ink usage, which is very important for painters.

In view of this, the present disclosure proposes a scheme capable of implementing a simulation of drawing operations to deliver real operations.

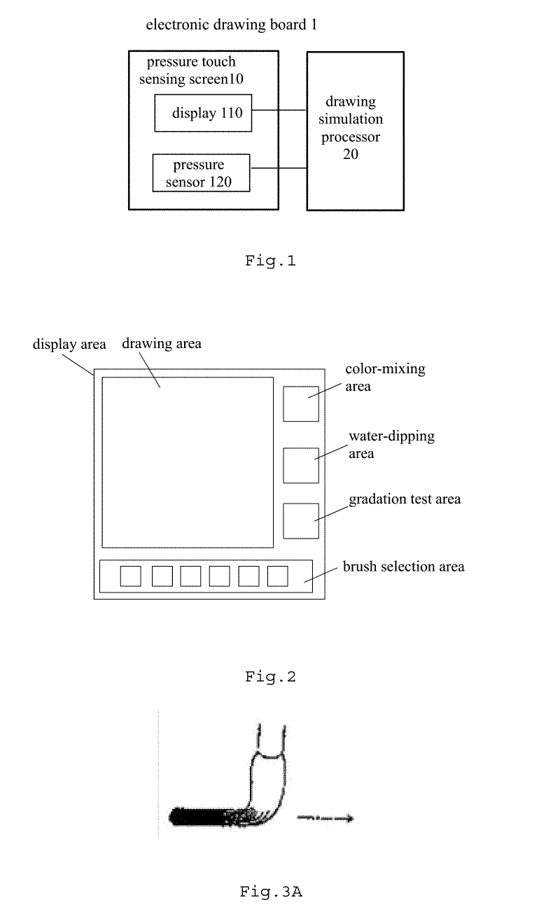

FIG. 1 is a schematic diagram illustrating the structure of an electronic drawing board according to some embodiments of the present disclosure.

As shown in FIG. 1, the electronic drawing board 1 includes a pressure touch sensing screen 10 and a drawing simulation processor 20.

The pressure touch sensing screen 10 is configured to sense a contact of a brush with the screen and display a stroke according to its thickness, direction, color, and gradation effect.

In some embodiments, the pressure touch sensing screen 10 includes: a display 110 having a display region configured to display a stroke according to its thickness, direction, color, and gradation effect; and a pressure sensor 120 arranged to be overlapped with the display region of the display and configured to sense a contact of the brush with the screen of the display.

FIG. 2 is a schematic diagram illustrating an interface of the electronic drawing board according to some embodiments of the present disclosure, i.e., a schematic diagram of the display region.

As shown in FIG. 2, the display region of the electronic drawing board includes a brush selection area, a color-mixing area, a water-dipping area, a gradation test area, and a drawing area. The drawing process will be described in detail below in conjunction with the various functional areas in FIG. 2.

In some embodiments, before the start of drawing, the desired brush is firstly selected in the brush selection area, color mixing is then performed in the color-mixing area according to a desired color, and the brush is dipped in water in the water-dipping area according to a gradation requirement. Before the start in the drawing area, it is also possible to make a test in the gradation test area to observe the gradation effect.

The drawing simulation processor 20 is configured to determine the effect of the actual drawing in the drawing area based on these specific operations.

In some embodiments, the drawing simulation processor 20 is configured to determine a stroke thickness according to a contact duration in which the brush contacts the screen when the brush is wielded on the screen. For example, the longer the contact duration of the brush with the screen, the thicker the stroke; otherwise, the finer the stroke. Also, a direction of the stroke can be determined based on a direction in which the brush is wielded on the screen.

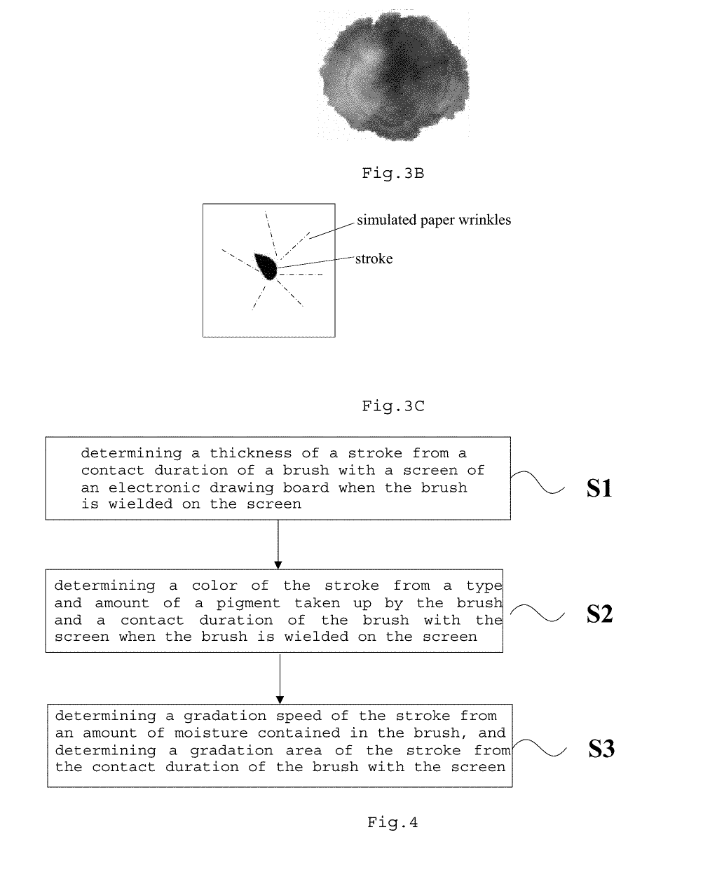

FIG. 3A is a schematic diagram illustrating a stroke simulation according to some embodiments of the present disclosure. As shown in FIG. 3A, at each contact point, the time duration in which the brush is in contact with the screen is approximately the same, and thus the thickness of the simulated stroke does not change substantially. The brush movement direction indicated by the arrow in FIG. 3A reflects the direction of the stroke.

In some embodiments, the drawing simulation processor 20 is configured to determine a stroke color according to the type and amount of a pigment taken up by the brush and the contact duration of the brush with the screen when the brush is wielded on the screen. Based on the principle of color mixing, the color of a stroke can be computed based on record data of the type and amount of a pigment selected by the user from the color-mixing area.

In some embodiments, the drawing simulation processor 20 is configured to determine a stroke gradation speed according to an amount of moisture contained in the brush, and determine a stroke gradation area according to the contact duration of the brush with the screen when the brush is wielded on the screen. For example, the more the moisture contained in the brush, the faster the gradation; otherwise, the slower the gradation. Further, a gradation area can be computed based on the determined gradation speed in conjunction with the contact duration of the brush with the screen when the brush is wielded on the screen.

FIG. 3B is a schematic diagram illustrating a gradation simulation according to some embodiments of the present disclosure. In the ink and wash drawing of FIG. 3B, an ink-washing gradation effect is displayed corresponding to the amount of moisture contained in the brush according to color mixing and water-dipping operations carried out by the user.

The amount of a pigment taken up by the brush and the amount of moisture contained in the brush depend on the number of times the brush is dipped in the color-mixing area and water-dipping area, as well as the pigment and water dipping duration. For example, the more times and the longer the duration, the more amount of pigment the brush takes up, otherwise, the less amount of pigment the brush takes up. Similarly, the more times and the longer the duration, the more amount of moisture the brush contains, otherwise, the less amount of moisture the brush contains.

In some embodiments, the brush selected from the brush selection area is a writing brush. The arrangement of the bristles of different types of brushes is different. Even for the same type of writing brush, it may produce different drawing effects with different contact portions with the display in the color-mixing, water-dipping operations, as well as the movement of the brush. The drawing simulation processor 20 takes these specific circumstances into account in the simulation.

For example, when the amount of moisture contained in the brush is determined, in addition to the number of times the brush is dipped in water and the water-dipping duration, the amount of moisture contained in the brush is further determined according to a water-dipping portion of the brush. If the water-dipping portion is the tip of the brush, a less amount of moisture is taken up by the brush. If the water-dipping portion is the abdominal portion of the brush, a greater amount of moisture is taken up by the brush.

Similarly, when the amount of a pigment taken up by the brush is determined, in addition to the number of times the brush is dipped in a pigment and the pigment-dipping duration, the amount of a pigment taken up by the brush is further determined according to a pigment-dipping portion of the brush. For example, if the pigment-dipping portion is the tip of the brush, a less amount of pigment is taken up by the brush. If the pigment-dipping portion is the abdominal portion of the brush, a greater amount of pigment is taken up by the brush.

In some embodiments, a difference in the portion of the brush in contact with the screen when the brush is wielded on the screen may further cause a difference in the thickness, gradation, and color of the stroke. For example, in a case that the portion of the brush that is in contact with the screen when the brush is wielded on the screen is the tip of the brush, the stroke is finer, resulting in a smaller gradation area and a higher color intensity. However, in a case that the portion of the brush that is in contact with the screen when the brush is wielded on the screen is the abdominal portion of the brush, the stroke is thicker, resulting in a larger gradation area and a lower color intensity.

During a drawing process, the water-dipping portion, the pigment-dipping portion of the brush and a contact portion of the brush when the brush is wielded on the screen can be determined according to a brush type and a magnitude of a contact force between the brush and the screen. For example, if the contact force is smaller, in general, the tip of the brush is in contact with the screen. If the contact force is larger, the abdominal portion of the brush may be in contact with the screen. The magnitude of the contact force may be sensed by a pressure sensor provided in the pressure touch screen.

In a practical drawing process, in addition to considering drawing effects of color mixing, gradation operations separately, an influence of paper type on the above operations may be further considered. Users may select different types of paper according to different demands. Different types of paper may be characterized by different colors or different textures. According to a user's selection, the color and texture of the selected paper may be displayed in the drawing area of FIG. 2. Accordingly, the drawing simulation processor 20 may simulate the color and texture of the selected paper. For example, in a simulation process, the drawing simulation processor 20 may determine the resistance of the paper to the brush when the brush is wielded on the screen, and a wrinkled effect caused by the brush on the paper while considering the surface texture of the selected paper (for example, the unevenness of the paper).

FIG. 3C is a schematic diagram illustrating a paper type simulation according to some embodiments of the present disclosure. FIG. 3C shows a simulated paper-wrinkled effect of a drawn stroke.

In some other embodiments, the drawing simulation processor 20 determines the color, gradation speed and gradation area of a stroke according to the paper type. For example, in a case of the same color-mixing and water-dipping operations, for Chinese paper, the stroke has a lighter color, a faster gradation speed and a larger gradation area; whereas for smooth paper, the stroke has a darker color, a slower gradation speed and a smaller gradation area. In addition, a mixed display effect of the color of the pigment taken up by the brush and the color of the paper will also be considered to determine the color of the stroke.

Below, the drawing simulation operation will be further described in conjunction with FIG. 4. FIG. 4 is a flowchart illustrating the steps of a drawing simulation method according to some embodiments of the present disclosure.

As shown in FIG. 4, the drawing simulation method comprises:

S1, determining a thickness of a stroke from a contact duration of a brush with a screen of an electronic drawing board when the brush is wielded on the screen;

S2, determining a color of the stroke from a type and amount of a pigment taken up by the brush and a contact duration of the brush with the screen when the brush is wielded on the screen; and

S3, determining a gradation speed of the stroke from an amount of moisture contained in the brush, and determining a gradation area of the stroke from the contact duration of the brush with the screen when the brush is wielded on the screen.

As described above, the amount of a pigment taken up by the brush is determined according to the number of times the brush is dipped in the pigment and a pigment-dipping duration, and the amount of moisture contained in the brush is determined according to the number of times the brush is dipped in water and a water-dipping duration. In a case that the brush is a writing brush, the amount of moisture contained in the brush and the amount of the pigment taken up by the brush may be further determined according to the portion of the brush that is in contact with the screen in the water-dipping and color-mixing operations; and the thickness, gradation area and color of the stroke are determined according to a portion of the brush that is in contact with the screen when the brush is wielded on the screen. The portion of the brush that is in contact with the screen may be determined according to a brush type and a contact force between the brush and the screen.

In some embodiments, the color and texture of the paper may be further displayed on the screen, and uneven and wrinkled surface effects of the paper may be simulated when the brush is wielded on the screen. As mentioned above, different paper types may cause different influence on the drawing effect of color-mixing and gradation operations. On this basis, when determining the color, gradation speed and gradation area of a stroke, the drawing simulation method further needs to consider the influence caused by different paper types, that is, to determine the color, gradation speed and gradation area of a stroke according a paper type.

It should be understood that the above sequence of the steps of the drawing simulation method is merely for the purpose of illustration, and steps S1 to S3 of the method of the present disclosure are not limited to the above-described specific order. For example, steps S1 to S3 may be performed at the same time, or may be sequentially performed in the order of S1, S2, and S3, and may be adjusted to the order of S2, S1, and S3. The execution of steps S1-S3 may be relatively independent of each other and performed by the corresponding modules separately.

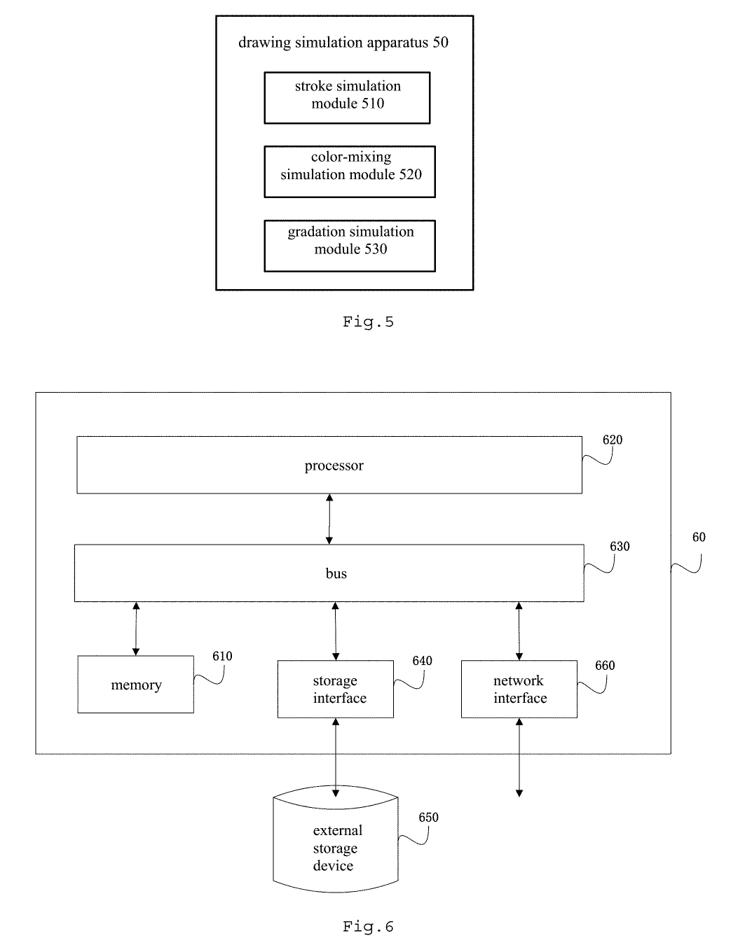

FIG. 5 is a schematic diagram illustrating the structure of a drawing simulation apparatus according to some embodiments of the present disclosure.

As shown in FIG. 5, the drawing simulation apparatus 50 includes a stroke simulation module 510, a color-mixing simulation module 520 and a gradation simulation module 530.

The stroke simulation module 510 determines the thickness of a stroke according to a contact duration in which a brush contacts a screen when the brush is wielded on the screen, for example, may execute step S1 of FIG. 4. In a case that the brush is a writing brush, the stroke simulation module 510 may further determine the thickness of a stroke according to a portion of the brush that is in contact with the screen when the brush is wielded on the screen.

The color-mixing simulation module 520 determines the color of the stroke according to the type and amount of a pigment taken up by the brush and the contact duration of the brush with the screen when the brush is wielded on the screen, for example, may execute step S2 of FIG. 4.

In some embodiments, the color-mixing simulation module 520 may determine the amount of a pigment taken up by the brush according to the number of times the brush is dipped in the pigment and a pigment-dipping duration. In a case that the brush is a writing brush, the color-mixing simulation module 520 may further determine the amount of a pigment taken up by the brush and the color of the stroke when the brush is wielded on the screen according to a portion of the brush that is in contact with the screen.

The gradation simulation module 530 determines a gradation speed of the stroke according to an amount of moisture contained in the brush, and determines a gradation area of the stroke according to the contact duration of the brush with the screen when the brush is wielded on the screen, for example, may execute step S3 of FIG. 4.

In some embodiments, the gradation simulation module 530 may determine the amount of moisture contained in the brush according to the number of times the brush is dipped in water and a water-dipping duration. In a case that the brush is a writing brush, the gradation simulation module 530 may further determine the amount of moisture contained in the brush and the gradation area of the stroke when the brush is wielded on the screen according to a portion of the brush that is in contact with the screen.

As mentioned above, the portion of the brush that is in contact with the screen may be determined according to a brush type and a contact force between the brush and the screen.

In some embodiments, since different paper types may have different influence on the drawing effect of color-mixing and gradation operations, the color-mixing simulation module 520 may further take the influence of a paper type into account when determining the color of a stroke. Similarly, the gradation simulation module 530 may further take the influence of a paper type into account when determining the gradation speed and gradation area of a stroke.

Those skilled in the art should understand that the method and apparatus of the present disclosure can be implemented in many ways. For example, the method and apparatus of the present disclosure may be implemented by software, hardware, firmware, or any combination of software, hardware, and firmware.

In some embodiments, all the stroke simulation module, the color-mixing simulation module, the gradation simulation module can be implemented by a processor in a general computing device executing instructions of corresponding steps stored in memory, by dedicated circuits executing corresponding steps or by a combination thereof.

FIG. 6 is a schematic diagram illustrating the structure of a drawing simulation apparatus according to some other embodiments of the present disclosure.

As shown in FIG. 6, the drawing simulation apparatus 60 comprises: a memory 610; a processor 620 coupled to the memory, the processor configured to, based on instructions stored in the memory, carry out the drawing simulation method according to any one of the previous embodiments.

The memory 610 may be a magnetic disk, flash memory or any other non-volatile storage medium. The memory 610 is configured to store the instructions of the corresponding embodiments of the drawing simulation method. In addition, the memory 610 may further include system memory configured to store, for example, an operating system, application programs, a boot loader, and other programs. The system memory may include a volatile storage medium such as random access memory (RAM) and/or cache memory.

The processor 620 is coupled to memory 610 and may be implemented as one or more integrated circuits, such as a microprocessor or microcontroller. In some embodiments, the processor 620 is coupled to the memory 610 through a bus 630 to execute the instructions stored therein to enable a simulation of drawing operations.

The drawing simulation apparatus 60 may be further connected to an external storage device 650 through a storage interface 640 to call external data, and may be further connected to a network or another computer system (not shown) through a network interface 660.

In the above embodiments, through storing data instructions in a memory and processing the above instructions using a processor, a simulation of drawing operations can be achieved.

In addition, in some embodiments, the present disclosure may take the form of a computer program product embodied on one or more computer-usable non-transitory storage media (comprising but not limited to disk storage, CD-ROM, optical memory, etc.) having computer-usable program code embodied therein. A computer program recorded in the recording medium includes machine-readable instructions for implementing the method according to the present disclosure, which, when executed by a processor, implements the drawing simulation method according to any one of the previous embodiments.

In the above embodiments, a simulation of the drawing operations is realized by calculating data about basic drawing operations such as gradation, color-mixing of the stroke, so that real drawing operations can be delivered.

An embodiment of the present disclosure further provide a remote teaching drawing board, comprising an electronic drawing board according to any one of the previous embodiments. The remote teaching drawing board may be a mobile phone, a tablet computer, a television, a notebook computer or any other product or component having display function.

In some embodiments, the electronic drawing board analyzes data inputted by a user, for example, compute and output data about a stroke and the color, gradation thereof according to the user's drawing operations. In other embodiments, the electronic drawing board can also extract colors captured with, for example, a camera, and convert the corresponding colors into corresponding color-mixing data through data analysis for output and display.

Here, the data analysis can be based on learning of history data of the drawing board, and can further be based on statistics of big data on network. By means of autonomous learning of large amounts of data, the accuracy of data analysis and thus the fidelity of the simulation can be improved.

In addition, the data input and output can be achieved by different pressure touch sensing screens, for example, on different electronic drawing boards. For example, in remote teaching, input of a drawing operation may be performed on the screens of some electronic drawing boards, and corresponding drawing data may be outputted on the screens of other electronic drawing boards. Users who learn to draw can use the drawing data to perform the corresponding drawing operations. Thus, effective delivery of real drawing operations can be achieved.

Heretofore, the electronic drawing board, the drawing simulation method and apparatus, the computer-readable storage medium, and the remote teaching drawing board according to the present disclosure have been described in detail. In order to avoid obscuring the concepts of the present disclosure, some details known in the art are not described. Based on the above description, those skilled in the art can understand how to implement the technical solutions disclosed herein.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified or equivalently substituted for part of the technical features without departing from the scope and spirit of the present disclosure. The scope of the disclosure is defined by the following claims.

What is claimed is:

1. An electronic drawing board, comprising:
a pressure touch sensing screen configured to sense a contact of a brush with a screen and display a stroke according to a thickness, direction, color, and gradation effect of the stroke; and
a drawing simulation processor configured to:
determine the thickness of the stroke from a contact duration of the brush with the screen when the brush is wielded on the screen,
determine the color of the stroke from a type and amount of a pigment taken up by the brush and the contact duration of the brush with the screen when the brush is wielded on the screen, and
determine a gradation speed of the stroke from an amount of moisture contained in the brush, and determine a gradation area of the stroke from the contact duration of the brush with the screen when the brush is wielded on the screen.

2. The electronic drawing board according to claim 1, wherein the drawing simulation processor is configured to determine an amount of a pigment taken up by the brush from the number of times the brush is dipped in the pigment and a pigment-dipping duration, and determine an amount of moisture contained in the brush from the number of times the brush is dipped in water and a water-dipping duration.

3. The electronic drawing board according to claim 1, wherein, in a case that the brush is a writing brush, the drawing simulation processor is configured to:
determine an amount of moisture contained in the brush from the number of times the brush is dipped in water, a water-dipping duration, and a water-dipping portion of the brush;
determine an amount of a pigment taken up by the brush from the number of times the brush is dipped in the pigment, a pigment-dipping duration, and a pigment-dipping portion of the brush; and
determine the thickness, gradation area and color of the stroke from a contact portion of the brush with the screen when the brush is wielded on the screen.

4. The electronic drawing board according to claim 3, wherein the drawing simulation processor is configured to determine the water-dipping portion and the pigment-dipping portion of the brush, and the contact portion of the brush with the screen when the brush is wielded on the screen, from a brush type and a magnitude of a contact force between the brush and the screen.

5. The electronic drawing board according to claim 1, wherein the drawing simulation processor is further configured to determine the color, gradation speed and gradation area of the stroke from a paper type.

6. The electronic drawing board according to claim 5, wherein the drawing simulation processor is further configured to determine a wrinkled effect caused by the brush on a paper from the paper type.

7. The electronic drawing board according to claim 1, wherein the pressure touch sensing screen comprises:
a display having a display region and configured to display the stroke from the thickness, direction, color, and gradation effect of the stroke; and
a pressure sensor arranged to be overlapped with the display region of the display and configured to sense the contact of the brush with the screen of the display.

8. The electronic drawing board according to claim 1, wherein the drawing simulation processor is further configured to determine the color, gradation speed and gradation area of the stroke from at least one of history data and external data of the electronic drawing board.

9. A remote teaching drawing board, comprising: at least one electronic drawing board according to claim 1.

10. The remote teaching drawing board according to claim 9, comprising: a plurality of the electronic drawing boards, wherein the pressure touch sensing screens of a portion of the electronic drawing boards are configured for inputting painting operations, and the pressure touch sensing screens of the other electronic drawing boards are configured for outputting painting data.

11. A drawing simulation method, comprising:
determining a thickness of a stroke from a contact duration of a brush with a screen of an electronic drawing board when the brush is wielded on the screen;
determining a color of the stroke from a type and amount of a pigment taken up by the brush and the contact duration of the brush with the screen when the brush is wielded on the screen; and
determining a gradation speed of the stroke from an amount of moisture contained in the brush, and determining a gradation area of the stroke from the contact duration of the brush with the screen when the brush is wielded on the screen.

12. The drawing simulation method according to claim 11, wherein the amount of a pigment taken up by the brush is determined from the number of times the brush is dipped in the pigment and a pigment-dipping duration, and the amount of moisture contained in the brush is determined from the number of times the brush is dipped in water and a water-dipping duration.

13. The drawing simulation method according to claim 11, wherein, in a case that the brush is a writing brush,
the amount of moisture contained in the brush is determined from the number of times the brush is dipped in water, a water-dipping duration, and a water-dipping portion of the brush;
the amount of a pigment taken up by the brush is determined from the number of times the brush is dipped in the pigment, a pigment-dipping duration, and a pigment-dipping portion of the brush; and
the thickness, gradation area and color of the stroke is determined from a contact portion of the brush with the screen when the brush is wielded on the screen.

14. The drawing simulation method according to claim 13, wherein the water-dipping portion, the pigment-dipping portion of the brush and the contact portion of the brush with the screen when the brush is wielded on the screen are determined from a brush type and a magnitude of a contact force between the brush and the screen.

15. The drawing simulation method according to claim 11, further comprising: determining the color, gradation speed and gradation area of the stroke from a paper type.

16. The drawing simulation method according to claim 15, further comprising: determining a wrinkled effect caused by the brush on a paper from the paper type.

17. The drawing simulation method according to claim 11, further comprising: determining the color, gradation speed and gradation area of the stroke from at least one of history data and external data of the electronic drawing board.

18. A drawing simulation apparatus, comprising:
a stroke simulation module for determining a thickness of a stroke from a contact duration of a brush with a screen of an electronic drawing board when the brush is wielded on the screen,
a color-mixing simulation module for determining a color of the stroke from a type and amount of a pigment taken up by the brush and the contact duration of the brush with the screen when the brush is wielded on the screen, and
a gradation simulation module for determining a gradation speed of the stroke from an amount of moisture contained in the brush, and determining a gradation area of the stroke from the contact duration of the brush with the screen when the brush is wielded on the screen.

19. A drawing simulation apparatus, comprising:
a memory; and
a processor coupled to the memory, the processor configured to, based on instructions stored in the memory, carry out the drawing simulation method according to claim 11.

20. A computer-readable storage medium on which a computer program is stored, which when executed by a processor implements the drawing simulation method according to claim 11.
